(19) United States
(12) Patent Application Publication
(10) Pub. No.: US 2010/0071294 A1
(43) Pub. Date: Mar. 25, 2010

(54) METAL COMPOSITE TILE

(75) Inventor: James T. Crunkleton, III, Waynesburg, KY (US)

Correspondence Address: MICHAEL BEST & FRIEDRICH LLP, 100 E WISCONSIN AVENUE, Suite 3300, MILWAUKEE, WI, 53202, US

(73) Assignee: ACOUSTIC CEILING PRODUCTS, L.L.C., Neenah, WI (US)

(21) Appl. No.: 12/504,971

(22) Filed: Jul. 17, 2009

Related U.S. Application Data
(60) Provisional application No. 61/192,730, filed on Sep. 22, 2008.

(51) Int. Cl. E04C 2/26; B32B 33/00

(52) U.S. Cl. 52/506.05; 428/40.1

(57) ABSTRACT

A metal composite tile includes a first metal sheet, a second metal sheet, a non-metal core disposed between and coupling the first and second metal sheets, and an adhesive disposed on a first side of the first metal sheet. The non-metal core is coupled to a second side of the first metal sheet. The metal composite tile also includes a release paper sheet adhered to the first side of the first metal sheet and covering the adhesive. The release paper sheet is removable from the first metal sheet to expose the adhesive.

### RELATED APPLICATIONS

This application claims priority to co-pending U.S. Provisional Patent Application Ser. No. 61/192,730 filed on Sep. 22, 2008, the entire content of which is incorporated herein by reference.

### FIELD OF THE INVENTION

The present invention relates to metal tiles, and more particularly to metal composite tiles for use in construction (e.g., residential construction).

### BACKGROUND OF THE INVENTION

Conventional tiles utilized in residential construction (e.g., installing a kitchen backsplash) are sold without any adhesive applied to the tiles, such that the individual installing the tiles must apply adhesive to each of the tiles prior to installation of the tiles. Such an installation process often leads to long installation times, and often requires a level of skill above that of the average homeowner.

### SUMMARY OF THE INVENTION

The present invention provides, in one aspect, a metal composite tile including a first metal sheet, a second metal sheet, a non-metal core disposed between and coupling the first and second metal sheets, and an adhesive disposed on a first side of the first metal sheet. The non-metal core is coupled to a second side of the first metal sheet. The metal composite tile also includes a release paper sheet adhered to the first side of the first metal sheet and covering the adhesive. The release paper sheet is removable from the first metal sheet to expose the adhesive.

The present invention provides, in another aspect, a metal composite tile including a composite sheet having a non-metal core, a first metal sheet bonded to a first side of the non-metal core, and a second metal sheet bonded to a second side of the non-metal core. The metal composite tile also includes an adhesive disposed on one side of the composite sheet, and a release paper sheet adhered to the side of the composite sheet and covering the adhesive. The release paper sheet is removable from the composite sheet to expose the adhesive.

The present invention provides, in yet another aspect, a wall covering including a first metal composite tile and a second metal composite tile engageable with the first metal composite tile. Each of the first and second metal composite tiles includes a composite sheet having a non-metal core, a first metal sheet bonded to a first side of the non-metal core, and a second metal sheet bonded to a second side of the non-metal core. Each of the first and second metal composite tiles further includes an adhesive disposed on one side of the composite sheet, and a release paper sheet adhered to the side of the composite sheet and covering the adhesive. The release paper sheet from each of the first and second metal composite tiles is removable to expose the adhesive on the respective first and second metal composite tiles prior to adhering the tiles to a wall.

Other features and aspects of the invention will become apparent by consideration of the following detailed description and accompanying drawings.

### BRIEF DESCRIPTION OF THE DRAWINGS

FIG. 1 is a front perspective view of a metal composite tile of the present invention.

FIG. 2 is a rear perspective view of the metal composite tile of FIG. 1.

FIG. 3 is a front perspective view of a wall covering comprised of a plurality of metal composite tiles of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

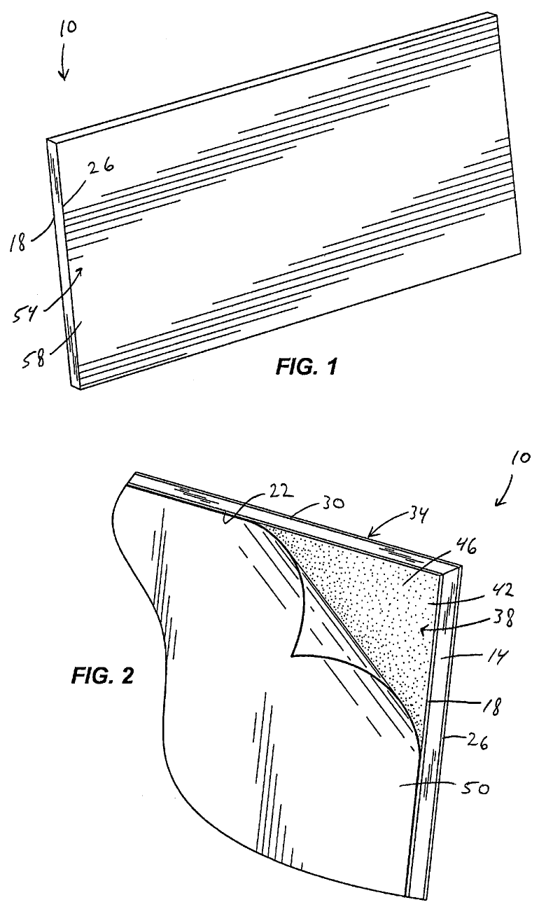

FIGS. 1 and 2 illustrate a metal composite tile 10 including a non-metal core 14, a first metal sheet 18 bonded to a first side 22 of the non-metal core 14, and a second metal sheet 26 bonded to a second side 30 of the non-metal core 14. Together, the non-metal core 14, the first metal sheet 18, and the second metal sheet 26 define a unitary, composite, laminated sheet 34 in which the first and second metal sheets 18, 26 may independently comprise at least one of aluminum, aluminum-containing compounds, an aluminum alloy, and combinations thereof. Alternatively, the first and second metal sheets 18, 26 may comprise other metals (e.g., copper, nickel, etc.), either alone or alloyed with aluminum. The non-metal core 14 may comprise at least one of a high density polyethylene polymer, a low density polyethylene polymer, an ultra-low density polyethylene polymer, a polypropylene polymer, other thermoplastics, and combinations thereof. Alternatively, the non-metal core 14 may be made of a fire or flame-retardant material that will not sustain or propagate a flame (e.g., perlite, calcium silicate, etc.). Such a composite sheet 34 having first and second metal sheets 18, 26 made of aluminum and the non-metal core 14 made of low-density polyethylene (otherwise known as aluminum composite material or “ACM”) is commercially available in bulk sizes from Alcan Composites USA Inc. of Benton, Ky. under the trade name ALUCOBOND (www.alucobondusa.com).

In the illustrated construction, the composite sheet 34 includes a length of about 6 inches and a height of about 3 inches. Alternatively, the composite sheet 34 may include any in a number of different dimensions (e.g., 4 inches×4 inches, 1 inch×6 inches, etc.) Also, in the illustrated construction of the metal composite tile 10, each of the first and second metal sheets 18, 26 includes a thickness of about 0.020 inches. Alternatively, the first and second metal sheets 18, 26 may include a different thickness depending upon the particular application of the metal composite tile 10.

With reference to FIG. 2, the composite sheet 34 includes a side 38, which correlates with a side 42 of the first metal sheet 18 that faces away from the non-metal core 14, upon which an adhesive 46 is disposed. In the illustrated construction of the metal composite tile 10, the adhesive 46 is a pressure-sensitive adhesive 46 and covers the entire side 38 of the composite sheet 34. One suitable silicone-based adhesive is DOW CORNING 7358 adhesive available from Dow Coming Corporation of Midland, Mich. Alternatively, the adhesive 46 may be acrylic-based or rubber-based (i.e., using natural or synthetic rubber) rather than silicone-based. As a further alternative, the adhesive 46 may be applied to only a portion of the composite sheet 34 rather than the entire side 38 of the composite sheet 34.

The metal composite tile 10 may also include a release paper sheet 50 adhered to the side 38 of the composite sheet 34 and covering the adhesive 46. In a construction of the metal composite tile 10 in which the adhesive 46 is only applied to a portion of the side 38 of the composite sheet 34, one or more release paper sheets 50 may be utilized to cover the discrete portions of adhesive on the composite sheet 34.

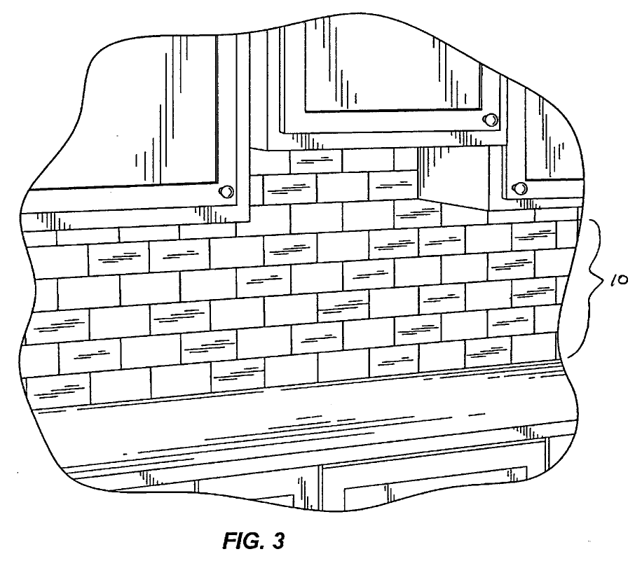

With reference to FIG. 1, the composite sheet 34 includes a second side 54, which correlates with a side 58 of the second metal sheet 26 that faces away from the non-metal core 14, upon which a coating is disposed. The coating may comprise a polyester polymer, a polytetrafluoroethylene polymer, a perfluoroalkoxy polymer, a fluorinated ethylene propylene polymer (e.g., TEFLON® available from E.I. du Pont de Nemours and Company), and combinations thereof. The second side 58 of the composite sheet 34 is visible upon installation of the metal composite tile 10 on a substrate (see FIG. 3). In one suitable embodiment, the polyester coating increases the fingerprint resistance of the metal composite tile 10, such that fingerprints are substantially prevented from leaving an impression on the visible side 58 of the metal composite tile 10. Alternatively, the visible, second side 58 of the composite sheet 34 may include other coatings to increase the fingerprint or scratch resistance of the metal composite tile 10. The second side 58 of the composite sheet 34 may also include a color coating separate from the polyester coating. Alternatively, the polyester coating may include a coloring agent in the polyester coating itself, such that a separate color coating is not required.

With reference to FIG. 3, the metal composite tiles 10 may be utilized to create a decorative wall covering (e.g., a kitchen backsplash). Alternatively, the metal composite tiles 10 may be utilized to cover other surfaces in a residence, home, or commercial location (e.g., a kick panel along the floor of the kitchen). The metal composite tiles 10 may be attached to underlying substrates such as primed drywall, plywood, oriented strand board or “OSB”, paneling, tile, and so forth. Prior to installation of the metal composite tiles 10, the underlying substrate is first cleaned, dried, and free from dust, grease, or wax. Isopropyl alcohol may be used to clean and prepare the surface of the substrate upon which the metal composite tiles 10 will be attached. The substrate may be primed using a high-quality primer.

With reference to FIG. 2, the release paper sheet 50 for each metal composite tile 10 is removed prior to installation of each tile 10. To remove the release paper sheet 50, one need only to peel back one of the corners of the release paper sheet 50, grasp the released corner of the paper sheet 50, and tear away the release paper sheet 50 from the composite sheet 34 to expose the adhesive 46. One may then attach the composite sheet 34 to the substrate by pressing the sheet 34 against the substrate, with the adhesive 46 facing the substrate, and holding the sheet 34 in position for a short period of time (e.g., between 5-10 seconds) to allow the adhesive 46 to set. Since one need not apply adhesive to each metal composite tile 10 prior to installation of the tiles 10, the installation time of the tiles 10 is reduced compared to the time required to install conventional ceramic or metal tiles, which require adhesive caulk to be applied to each tile prior to installation.

As shown in FIG. 3, the metal composite tiles 10 may be arranged on a substrate to create a decorative pattern. Should the metal composite tiles 10 require cutting during the course of installation, a utility knife may be used to score the tile 10 according to a custom length or shape (prior to removal of the release paper sheet 50). A chisel may be used to deepen the score line created by the utility knife. Upon the score line in the tile 10 reaching a sufficient depth using the utility knife and/or chisel, one may bend the tile 10 back and forth about the score line until the tile 10 separates. A fine-grit sandpaper or small metal file may then be used to deburr the edges of the newly cut tile 10.

Various features of the invention are set forth in the following claims.

What is claimed is:

1. A metal composite tile comprising:
a first metal sheet;
a second metal sheet;
a non-metal core disposed between and coupling the first and second metal sheets;
an adhesive disposed on a first side of the first metal sheet, the non-metal core coupled to a second side of the first metal sheet; and
a release paper sheet adhered to the first side of the first metal sheet and covering the adhesive, the release paper sheet being removable from the first metal sheet to expose the adhesive.

2. The metal composite tile of claim 1, wherein at least one of the first and second metal sheets comprises aluminum.

3. The metal composite tile of claim 2, wherein both of the first and second metal sheets comprise aluminum.

4. The metal composite tile of claim 1, wherein the non-metal core comprises a plastic material.

5. The metal composite tile of claim 4, wherein the non-metal core comprises polyethylene.

6. The metal composite tile of claim 1, wherein the adhesive is at least one of acrylic-based and rubber-based.

7. The metal composite tile of claim 1, wherein the adhesive covers the entire first side of the first metal sheet.

8. The metal composite tile of claim 7, wherein the release paper sheet covers the entire first side of the first metal sheet.

9. The metal composite tile of claim 1, wherein the second metal sheet includes
a first side; and
a second side coupled to the non-metal core.

10. The metal composite tile of claim 9, further comprising a polyester coating disposed on the first side of the second metal sheet.

11. A metal composite tile comprising:
a composite sheet including
a non-metal core;
a first metal sheet bonded to a first side of the non-metal core;
a second metal sheet bonded to a second side of the non-metal core;
an adhesive disposed on one side of the composite sheet; and
a release paper sheet adhered to the side of the composite sheet and covering the adhesive, the release paper sheet being removable from the composite sheet to expose the adhesive.

12. The metal composite tile of claim 11, wherein at least one of the first and second metal sheets comprises aluminum.

13. The metal composite tile of claim 12, wherein both of the first and second metal sheets comprise aluminum.

14. The metal composite tile of claim 11, wherein the non-metal core comprises a plastic material.

15. The metal composite tile of claim 14, wherein the non-metal core comprises polyethylene.

16. The metal composite tile of claim 11, wherein the adhesive is at least one of acrylic-based and rubber based.

17. The metal composite tile of claim 11, wherein the adhesive covers the entire side of the composite sheet.

18. The metal composite tile of claim 17, wherein the release paper sheet covers the entire side of the composite sheet.

19. The metal composite tile of claim 11, wherein the adhesive is disposed on a first side of the composite sheet, and wherein the composite sheet includes a second side having a polyester coating.

20. The metal composite tile of claim 11, wherein the non-metal core is flame-retardant.

21. A wall covering comprising:
a first metal composite tile;
a second metal composite tile engageable with the first metal composite tile, each of the first and second metal composite tiles including
a composite sheet having
a non-metal core;
a first metal sheet bonded to a first side of the non-metal core;
a second metal sheet bonded to a second side of the non-metal core;
an adhesive disposed on one side of the composite sheet; and
a release paper sheet adhered to the side of the composite sheet and covering the adhesive;
wherein the release paper sheet from each of the first and second metal composite tiles is removable to expose the adhesive on the respective first and second metal composite tiles prior to adhering the tiles to a wall.
